(19) United States
(12) Patent Application Publication
(10) Pub. No.: US 2025/0270057 A1
(43) Pub. Date: Aug. 28, 2025

(54) CASE SEQUENCER AND BUFFER SYSTEM

(71) Applicant: Walmart Apollo, LLC, Bentonville, AR (US)

(72) Inventor: Santos Cerda, JR., Centerton, AR (US)

(21) Appl. No.: 19/051,040

(22) Filed: Feb. 11, 2025

Related U.S. Application Data
(60) Provisional application No. 63/556,822, filed on Feb. 22, 2024.

(51) Int. Cl. B65G 43/08; B07C 5/04; B07C 5/36; B65G 33/02; B65G 47/51

(52) U.S. Cl. CPC B65G 43/08; B07C 5/04; B07C 5/36; B65G 33/02; B65G 47/5104; B65G 2203/041

(57) ABSTRACT

Examples provide a case sequencer for sequencing and buffering of items in accordance with sizing attributes of each item. A first vertical transport mechanism and a second vertical transport mechanism are connected to a plurality of slidable queuing beds located at a plurality of different levels along the vertical length of each vertical transport mechanism. Sensor data is used to sort items by size, weight, shape, or other dimensions. Items exit onto the queuing beds at different levels based on item dimensions for buffering. Items of similar size exit the second vertical transport together. Each slidable queueing bed is capable of sliding outward to the side or back for maintenance and/or repair. Multiple queuing beds at different levels can be pulled out for maintenance at the same time. The case sequencer can continue operation as long as at least one queuing bed remains retracted and operable.

### BACKGROUND

It is frequently desirable to sort cases of items in accordance with the size, shape, weight, height, or other dimensions of the case. Having similarly sized cases sorted together can enable users to pack more cases together into pallets, load cases more efficiently into a truck, stack cases more neatly and securely, leave a smaller footprint when stacked, organize cases for unloading or unpacking, etc. However, cases are typically unloaded from a truck or other cargo container in random order without regard for size, shape, or weight. Moreover, organizing cases by size-related attributes is generally performed manually by human users. This is an inefficient, time-consuming, and inefficient process.

### SUMMARY

Some examples provide a case sequencer having a pair of vertical transport mechanisms connecting a plurality of slidable case queuing beds arranged at a plurality of levels between the two vertical transport mechanisms. A set of sensors generates sensor data used to identify the size, height, weight, and/or other dimensions of each item entering the first vertical transport mechanism. A conveyor moves items onto a plurality of slidable queuing beds arranged between the first and second vertical transport mechanisms at a plurality of levels. Each level accommodates items having different dimensions. A first set of items having a first set of dimensions move onto a first slidable queuing bed at a first level. A second set of items having a second set of dimensions move onto a second slidable queuing bed at a second level. Sliding mechanisms enable the queuing beds to slide out horizontally from a retracted position in an operable state to an extended position in an inoperable state via a sliding mechanism. Items of similar size are buffered at each level. The first set of items having the first set of dimensions are held in a first storage area for release from a second vertical transport mechanism substantially simultaneously. The second set of items having the second set of dimensions are held in a second storage area for release from the second vertical transport mechanism substantially simultaneously.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for sequencing and buffering items via a case sequencer.

FIG. 2 is an exemplary block diagram illustrating a case sequencer for sorting and buffering items based on the item sizing attributes.

FIG. 3 is an exemplary block diagram illustrating a case sequencer having a set of spiral conveyors and a set of case queuing beds for sequencing and buffering items.

FIG. 4 is a block diagram illustrating a cross-section view of a case sequencer.

FIG. 5 is a block diagram illustrating a case queuing bed housing having a plurality of slidable queuing beds.

FIG. 6 is a block diagram illustrating a case sequencer for sequencing items based on size-related attributes of each item.

FIG. 7 is a block diagram illustrating a computing device for analyzing sensor data used to sequence items in accordance with size-related attributes of each item.

FIG. 8 is an exemplary flow chart illustrating operation of the computing device to sort and sequence items via a case sequencer.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . .” For brevity and clarity of presentation, this implied leading clause is not repeated ad nauseum.

It is frequently difficult to manage cases, boxes, packages, and other items at distribution centers because freight is processed at random. This makes it difficult to anticipate a sequence for building pallets, loading, or unloading trucks, or other tasks. These processes can be significantly improved by sequencing and buffering items based on item dimensions, such as height, weight, size, shape, etc.

Referring to the figures, examples of the disclosure enable a case sequencer for sorting and buffering items based on size-related attributes, such as, but not limited to, size, shape, height, length, width, and/or weight of the items. The items can include boxes, packages, cases, pallets, or any other type of items. The case sequencer enables buffering of similar items (heights, weight, cube, etc.) without need for extensive vision systems or infrastructure with improved maintenance accessibility.

In other examples, the system includes a plurality of slidable queuing beds at a plurality of different levels which enables users to pull an entire queuing bed at a given level out to the side or back for preventative maintenance and/or component replacement. This provides for ease of maintenance and elimination of downtime during maintenance and repairs. Moreover, the entire system can continue to operate as long as at least one level is “active.”

In other examples, the vertical transport mechanism is a spiral conveyor. The spiral conveyor minimizes the footprint of the vertical transport mechanism enabling the case sequencer to move items vertically to various levels for sequencing while reducing the amount of floor space consumed by the vertical transport mechanism.

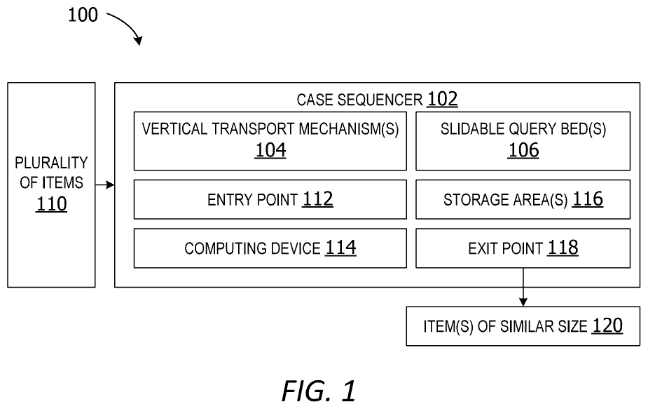

Referring to FIG. 1, an exemplary block diagram illustrating a system 100 for sequencing and buffering items via a case sequencer is shown. In some examples, the system 100 includes one or more vertical transport mechanisms(s) 104 connected to one or more slidable queuing bed(s) 106. A vertical transport mechanism is a device for moving a plurality of items 110 from an entry point 112 at a top portion of the vertical transport mechanism down a series of one or more conveyors. In some non-limiting examples, the vertical transport mechanism(s) 104 are implemented as one or more spiral conveyors.

In this example, the entry point 112 is at a top of the vertical transport mechanism and the items move downward through the vertical transport mechanism. However, the embodiments are not limited to a vertical transport mechanism in which items move from downward. In other embodiments, the entry point is located at a bottom portion of the vertical transport mechanism and the items move upward through the vertical transport mechanism, enabling items to be routed onto various different levels as the items move up from the bottom to the top. In still other embodiments, the items move within the vertical transport mechanism in both vertical movements as well as horizontal movements as the items are routed onto the various levels. In this manner, items can be moved through the vertical transport mechanism in a top down fashion or in an opposite bottom up direction, as needed.

In some examples, a computing device 114 analyzes sensor data associated with each item in the plurality of items 110 entering a first vertical transport mechanism and identifies a slidable queuing bed accepting items within a range of sizes, weights, shapes, and/or other dimensions. The computing device 114 implements queue logic for sorting and queuing the items based on the dimensions and other sensor data for each item.

The slidable queuing bed(s) 106 move the items of similar size along a horizontal platform toward a second vertical transport mechanism. Each set of similar sized items can be held in one or more storage area(s) 116 such that items of similar size 120 can be released at an exit point 118 in a user-configurable sequence.

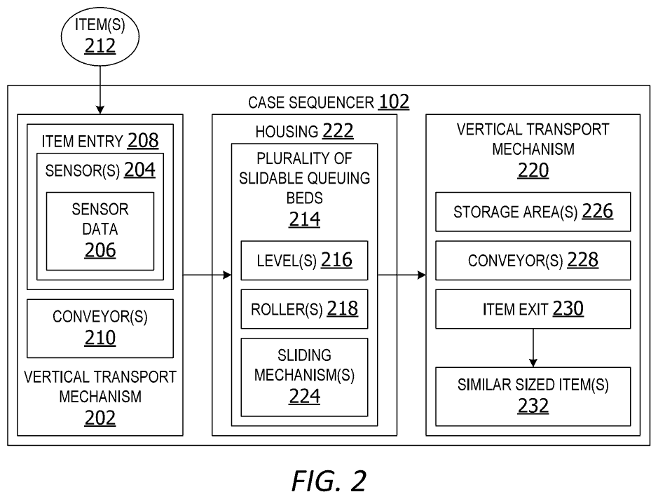

FIG. 2 is an exemplary block diagram illustrating a case sequencer 102 for sorting and buffering items based on the item sizing attributes. A first vertical transport mechanism 202 is a mechanism for moving items down a series of one or more conveyors, such as, but not limited to, the vertical conveyor mechanism(s) 104 in FIG. 1. In this example, the first vertical transport mechanism 202 includes a set of one or more sensor(s) 204 associated with an entry point 208. The set of sensor(s) 204 include sensors for obtaining measuring and weighting information for the item(s) 212. The sensor(s) 204 in some examples include one or more dimensioners, one or more weight sensors, one or more scanner devices, and/or one or more image capture devices. A scanner device is a device for reading a unique identifier (UID) on an item, such as, but not limited to, a universal product code (UPC), a radio frequency identifier (RFID) tag, a matrix barcode, a quick response (QR) code, or any other type of UID.

In this example, the sensor(s) are located within an item entry point 208 where the item(s) 212 enter the vertical transport mechanism 202 at or above the highest level in the one or more level(s) 216. However, in other examples, one or more sensor(s) may be located at one or more locations throughout the vertical transport mechanism 202 generating sensor data describing the items as the items move down through the vertical transport mechanism 202.

The sensor(s) 204 generates sensor data 206 associated with a set of dimensions of each item entering the first vertical transport mechanism at the entry point 208. The dimensions optionally include the height, length, and/or width of the item(s) 212 entering the first vertical transport mechanism 202.

The first vertical transport mechanism 202 optionally includes a set of one or more conveyor(s) 210 for moving the item(s) 212 entering the first vertical transport mechanism 202 at the item entry point 208 onto a plurality of slidable queuing beds 214 at one or more level(s) 216 based on the dimensions or other size-related attributes of each of the item(s) 212. In other words, items are sorted based on size and routed to different queuing beds based on the size or other dimensions of the items.

For example, the largest items can be routed to the queuing bed at one level and the smallest items can be routed to the queuing bed at a different level. A queuing bed in the plurality of slidable queuing beds 214 includes a horizontal platform having one or more roller(s) 218 for moving items having similar sizing dimensions from the first vertical transport mechanism 202 to a second vertical transport mechanism 220.

A queuing bed housing 222 in some examples includes one or more sliding mechanism(s) 224 associated with each queuing bed in the plurality of sliding queuing beds 214. Each queuing bed slides horizontally from a retracted position in an operable state to an extended position in an inoperable state via the one or more sliding mechanism(s) 224. A sliding mechanism is any type of device or mechanism that enables a queuing bed to slide out from the housing 222. For example, the sliding mechanism can include drawer slides.

The vertical transport mechanism 220 optionally includes one or more conveyor(s) 228 for moving similar sized item(s) 232 exiting each queuing bed in the plurality of slidable queuing beds 214.

In other examples, the case sequencer 102 includes one or more storage area(s) 226 for storing items of similar size that are exiting the plurality of slidable queuing beds 214. For example, a first set of items having a first set of dimensions are held in a first storage area for release from the second vertical transport mechanism substantially simultaneously while a second set of items having the second set of dimensions are held in a second storage area. In some examples, similar sized item(s) 232 are released from the second vertical transport mechanism together 220 via the item exit 230.

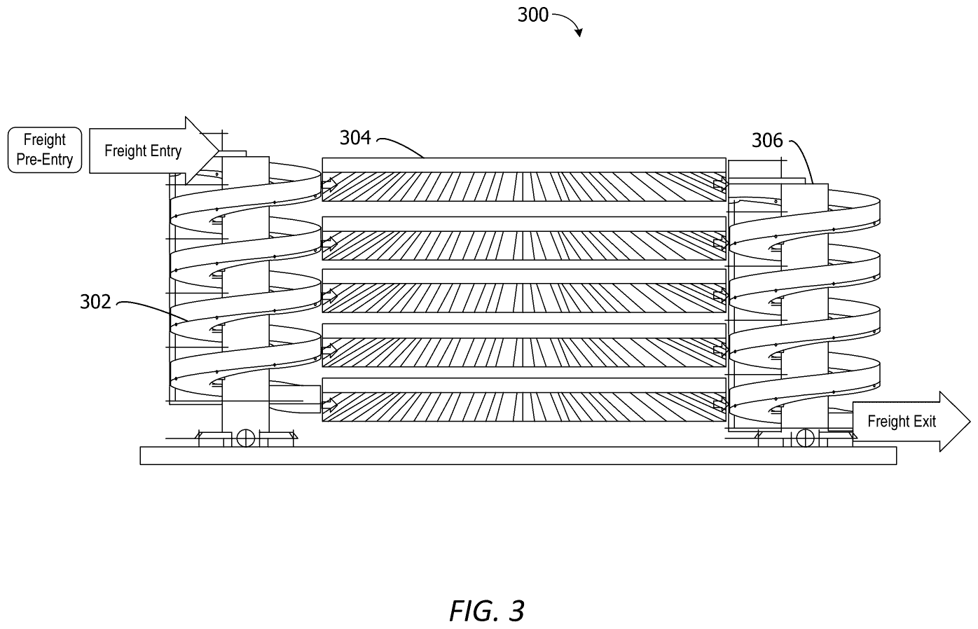

Turning now to FIG. 3, an exemplary block diagram illustrating a case sequencer 300 having a set of spiral conveyors and a set of case queuing beds for sequencing and buffering items is shown. The case sequencer 300 is an apparatus for sequencing and buffering items, such as, but not limited to, the case sequencer 102 in FIG. 1 and/or the case sequencer 102 in FIG. 2.

The case sequencer 300 includes a first vertical transport mechanism 302 and a second vertical transport mechanism 306 connected to a plurality of case queuing beds 304. The case queuing beds include one or more queuing beds, such as, but not limited to, the slidable queuing bed(s) 106 in FIG. 1 and/or the plurality of slidable queuing beds 214 in FIG. 2.

In some examples, the first vertical transport mechanism 302 and the second vertical transport mechanism 306 are implemented as spiral conveyor devices. As cases, or other items, move down the conveyors in the first vertical transport mechanism 302, items of various sizes are moved onto queuing beds at different levels.

The case sequencer 300, in this example includes five case queuing beds at five different levels. The items of a first size are pulled or pushed by the conveyor and/or rollers onto a first case queuing bed at a first level. Items of a second size are pulled or pushed onto a second case queuing bed at a second level. Items of a third size are pulled or pushed onto a third case queuing bed at a third level. Items of a fourth size are pulled or pushed onto a fourth case queuing bed at a fourth level. The items of a fifth size are pulled or pushed onto a fifth case queuing bed at a fifth level.

The items of similar size and/or other dimensions at each level are buffered until the items at that level are ready for release together via the second vertical transport mechanism 306. In some examples, the items at each level are released in a pre-defined sequence. For example, all items at the lowest (fifth) level are released from the second vertical transport mechanism first, permitting all the items of similar size at the lowest level to exit the case sequencer together. The items at the next lowest level (fourth) level are released next. Then the items at the third level are released followed by the items at the second level. In this example, the items at the highest level are released last.

In other examples, the items are released from the second vertical transport mechanism in sequence starting with the first (highest) level and finishing with the lowest (fifth) level. In still other examples, items are released from each level (storage area) in a user-defined sequence.

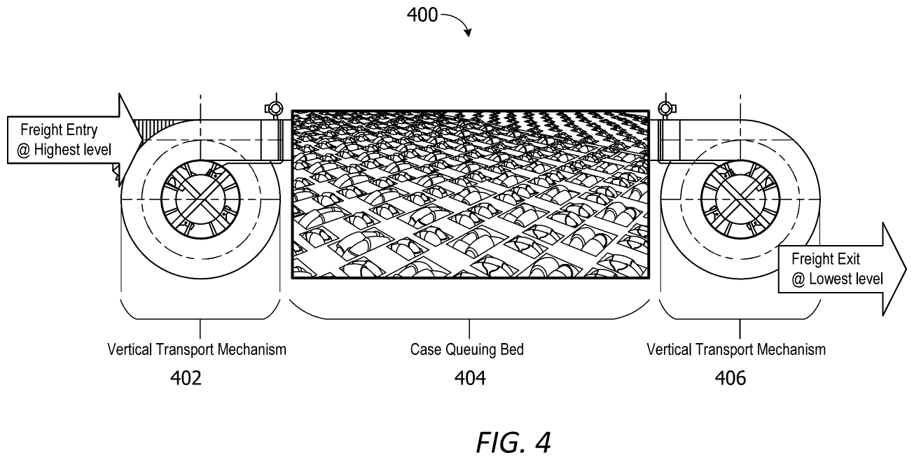

FIG. 4 is a block diagram illustrating a cross-section view of a case sequencer 400. The case sequencer 400 is a device for sequencing and buffering items, such as, but not limited to, the case sequencer 102 in FIG. 1, the case sequencer 102 in FIG. 2 and/or the case sequencer 300 in FIG. 3.

In some examples, items having size attributes within a user-configurable range of size attributes exit the vertical transport mechanism 402 at a portion of the vertical transport mechanism connecting to a selected case queuing bed 404 for items within the range. A plurality of rollers on the case queuing bed push or pull the item(s) across the case queuing bed toward a portion of the second vertical transport mechanism 406 connected to the selected case queuing bed. When a predetermined event occurs, the items collected at the case queuing bed 404 are released together to move down the remainder of the second vertical transport via one or more conveyors to an exit point. A set of one or more items of similar size, weight, shape, and/or other dimensions exit the case sequencer together.

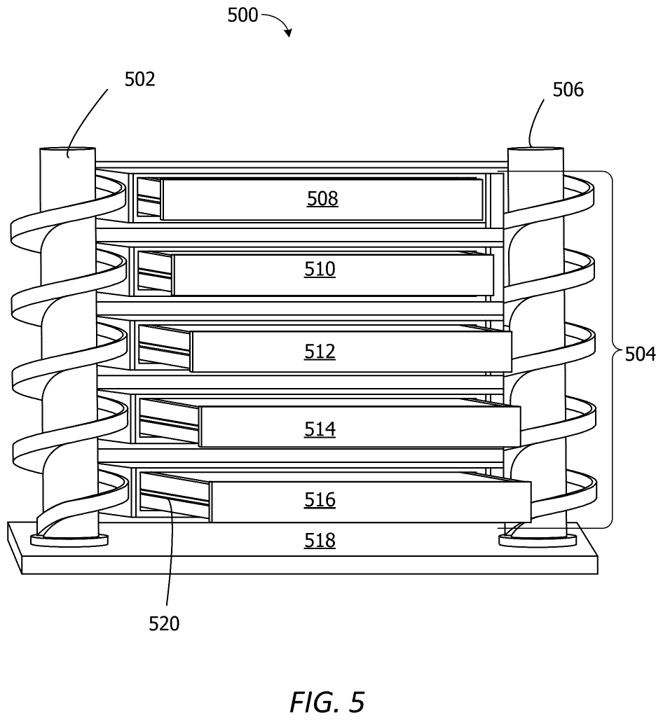

Referring now to FIG. 5, a block diagram illustrating a case queuing bed housing 504 having a plurality of slidable queuing beds is shown. In this example, a case sequencer 500 includes a case queuing bed housing 504 between a first vertical transport mechanism 502 and a second vertical transport mechanism 506. The case queuing bed housing 504 provides a frame or other support structure for supporting one or more item queuing beds, such as, but not limited to, the housing 222 in FIG. 2.

The case queuing beds in the case queuing bed housing 504 include one or more horizontal platforms having rollers and/or conveyors for moving similar sized items horizontally from the first vertical transport mechanism to the second vertical transport mechanism at each level. The width, length, and heights of roller beds on the slidable queuing beds varies based on specific applications. In this example, the case queuing bed housing 504 includes a queuing bed 508 at a top level, a queuing bed 510, a queuing bed 512, a queuing bed 514, and a bottom queuing bed 516 just above a base member 518 of the case sequencer 500. However, the embodiments are not limited to five queuing beds. The case sequencer can include two or more queuing beds. In other embodiments, the case sequencer includes four queuing beds, six queuing beds or any other number of queuing beds.

Each case queuing bed is slidable from a retracted position to an extended position via a sliding mechanism, such as, but not limited to, the sliding mechanism 520 associated with the case queuing bed 516. The sliding mechanism can be implemented as any type of mechanism enabling a case queuing bed to pull out to a side of the case queuing bed housing 504, the back of the housing, or the front of the case queuing bed housing 504, as shown in FIG. 5. In this example, the case queuing bed housing 504 supports five case queuing beds at five different levels partially pulled out of the case queuing bed housing 504. However, the embodiments are not limited to five case queuing beds. In other examples, the housing includes two or more case queuing beds at two or more different levels.

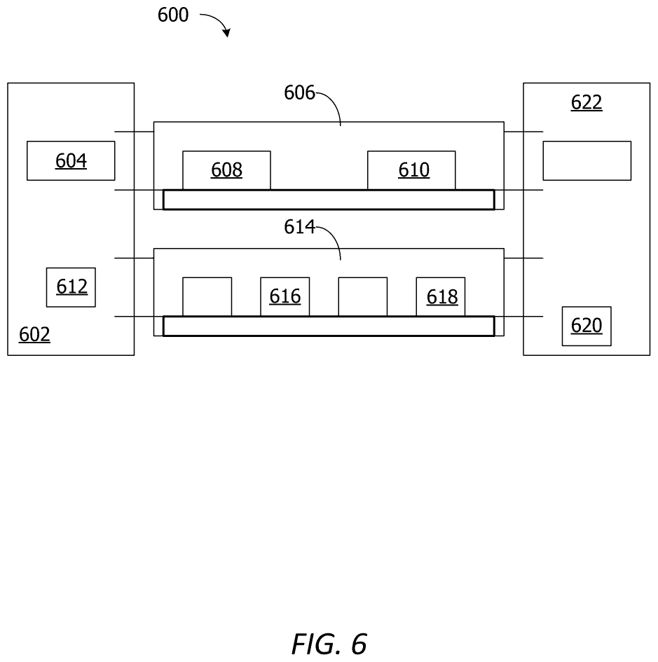

FIG. 6 is a block diagram illustrating a case sequencer 600 for sequencing items based on size-related attributes of each item. In this example, a first item 604 of a first size exits the first vertical transport mechanism 602 at a first level 606 with similarly sized items 608 and 610. The items 604, 608 and 610 are buffered at the first level until a predetermined event occurs triggering release of the similarly sized items. The predetermined even can include any type of event, such as a predetermined time, one or more other sets of items at lower levels being released, a user triggering release of the items via a control or other switch, a software component triggering release of the items buffered at one or more levels, a threshold number of items being collected at a given level, etc.

The item 612, in this example, continues on down the conveyors(s) to the second level 614 where a second set of similarly sized items are collected. The second set of items includes the item 612, the item 616, the item 618, and the item 620. The second set of items are released from the second level 614 through the second vertical transport mechanism 622 at the occurrence of a predetermined event.

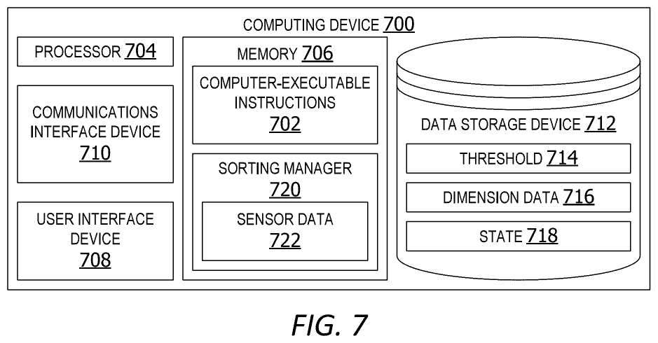

FIG. 7 is a block diagram illustrating a computing device 700 for analyzing sensor data used to sequence items in accordance with size-related attributes of each item. The computing device 700 is a device for analyzing sensor data and sequencing items based on size-related attributes of items, such as, but not limited to, the computing device 114 in FIG. 1. In the example of FIG. 7, the computing device 700 represents any device executing computer-executable instructions 702 (e.g., as application programs, operating system functionality, or both) to implement the operations and functionality associated with the computing device 700.

The computing device 700, in some examples includes a mobile computing device or any other portable device. A mobile computing device includes, for example but without limitation, a mobile telephone, laptop, tablet, computing pad, netbook, gaming device, and/or portable media player. The computing device 700 can also include less-portable devices such as servers, desktop personal computers, kiosks, or tabletop devices. Additionally, the computing device 700 can represent a group of processing units or other computing devices.

In some examples, the computing device 700 has at least one processor 704 and a memory 706. The computing device 700, in other examples includes a user interface device 708.

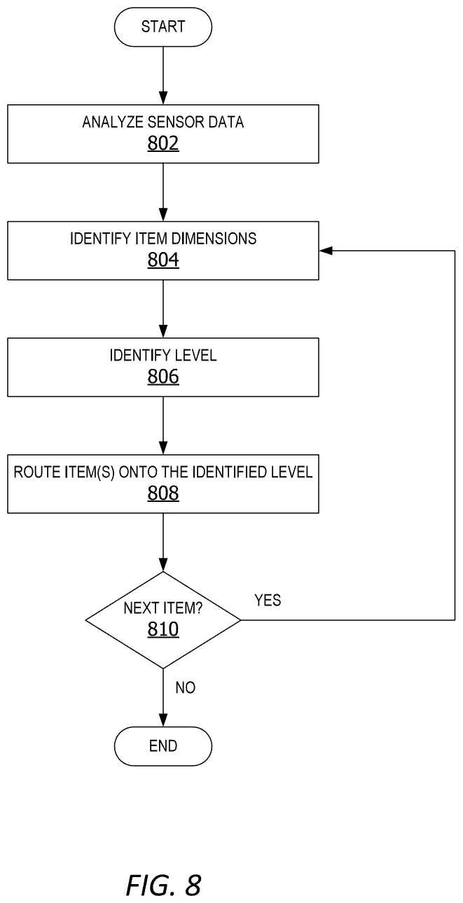

The processor 704 includes any quantity of processing units and is programmed to execute the computer-executable instructions 702. The computer-executable instructions 702 are performed by the processor 704, performed by multiple processors within the computing device 700 or performed by a processor external to the computing device 700. In some examples, the processor 704 is programmed to execute instructions such as those illustrated in the figures (e.g., FIG. 8).

The computing device 700 further has one or more computer-readable media such as the memory 706. The memory 706 includes any quantity of media associated with or accessible by the computing device 700. The memory 706 in these examples is internal to the computing device 700 (as shown in FIG. 7). In other examples, the memory 706 is external to the computing device (not shown) or both (not shown). The memory 706 can include read-only memory and/or memory wired into an analog computing device.

The memory 706 stores data, such as one or more applications. The applications, when executed by the processor 704, operate to perform functionality on the computing device 700. The applications can communicate with counterpart applications or services such as web services accessible via a network. In an example, the applications represent downloaded client-side applications that correspond to server-side services executing in a cloud.

In other examples, the user interface device 708 includes a graphics card for displaying data to the user and receiving data from the user. The user interface device 708 can also include computer-executable instructions (e.g., a driver) for operating the graphics card. Further, the user interface device 708 can include a display (e.g., a touch screen display or natural user interface) and/or computer-executable instructions (e.g., a driver) for operating the display. The user interface device 708 can also include one or more of the following to provide data to the user or receive data from the user: speakers, a sound card, a camera, a microphone, a vibration motor, one or more accelerometers, a BLUETOOTH® brand communication module, wireless broadband communication (LTE) module, global positioning system (GPS) hardware, and a photoreceptive light sensor. In a non-limiting example, the user inputs commands or manipulates data by moving the computing device 700 in one or more ways.

The network is implemented by one or more physical network components, such as, but without limitation, routers, switches, network interface cards (NICs), and other network devices. The network is any type of network for enabling communications with remote computing devices, such as, but not limited to, a local area network (LAN), a subnet, a wide area network (WAN), a wireless (Wi-Fi) network, or any other type of network. In this example, the network is a WAN, such as the Internet. However, in other examples, the network is a local or private LAN.

In some examples, the computing device 700 optionally includes a communications interface device 710. The communications interface device 710 includes a network interface card and/or computer-executable instructions (e.g., a driver) for operating the network interface card. Communication between the computing device 700 and other devices can occur using any protocol or mechanism over any wired or wireless connection. In some examples, the communications interface device 710 is operable with short range communication technologies such as by using near-field communication (NFC) tags.

The system 100 can optionally include a data storage device 712 for storing data, such as, but not limited to a threshold 714, dimension data 716, and/or state 718 of each queuing bed in the case sequencer. The threshold 714 is a threshold maximum number of case queuing beds that can be pulled out in a fully extended or partially extended position. The number of levels allowed to be pulled out at once varies based on limitations on upward forces on concrete slab (pre-installation analysis required) to prevent tipping. In some examples, the maximum threshold number of levels which can be pulled out at once is determined based on upward forces on a slab.

The dimension data 716 includes the dimensions, weight and other size-related data describing each item. The state 718 indicates an operability state of each case queuing bed. If a bed is extended, it is in an inoperable state. If the queuing bed is retracted, the queuing bed can be operable or inoperable.

The data storage device 712 can include one or more different types of data storage devices, such as, for example, one or more rotating disks drives, one or more solid state drives (SSDs), and/or any other type of data storage device. The data storage device 712 in some non-limiting examples includes a redundant array of independent disks (RAID) array. In some non-limiting examples, the data storage device(s) provide a shared data store accessible by two or more hosts in a cluster. For example, the data storage device may include a hard disk, a redundant array of independent disks (RAID), a flash memory drive, a storage area network (SAN), or other data storage device. In other examples, the data storage device 712 includes a database.

The data storage device 712 in this example is included within the computing device 700, attached to the computing device, plugged into the computing device, or otherwise associated with the computing device 700. In other examples, the data storage device 712 includes a remote data storage accessed by the computing device via the network, such as a remote data storage device, a data storage in a remote data center, or a cloud storage.

The memory 706 in some examples stores a sorting manager 720 component, that when executed by the processor 704 of the computing device 700, analyzes the sensor data 722 associated with the items entering the vertical transport mechanism. The sensor data 722 is used to identify dimension data 716, such as, but not limited to, the height of an item, the width of an item, the length of an item, the weight of an item, the shape of an item, etc. The sorting manager 720 uses the sensor data to identify a level for the item. The item is routed to the appropriate level based on the dimensions of the item by the sorting manager component.

FIG. 8 is an exemplary flow chart illustrating operation of the computing device to sort and sequence items via a case sequencer. The process shown in FIG. 8 is performed by a sorting manager component, executing on a computing device, such as the computing device 114 in FIG. 1 and/or the computing device 700 in FIG. 7.

The process begins by analyzing sensor data associated with one or more items at 802. Item dimensions are identified at 804. The sorting manager identifies a level in the case sequencer for each item based on the identified item dimensions at 806. The sorting manager routes the item(s) onto the identified level at 808. A determination is made whether a next item is waiting to be routed to an appropriate queuing bed at 810. If yes, the process iteratively executes operations 802 through 810 until no additional items remain to be routed onto a queuing bed based on the size and/or other dimensions of each item at 810. The process terminates thereafter.

While the operations illustrated in FIG. 8 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 8.

### Additional Examples

In some examples, the system provides for automatically sorting incoming packages/boxes by size, weight, height, and/or dimensions. The system uses a combination of two spiral conveyors, scanning equipment, case dimensioners for measuring pallets and boxes. The system uses wheel conveyor beds running between two spiral conveyors at various levels. This enables similar-sized packages/boxes to exit the case sequencer together, allowing for buffering of similar cases (without need for extensive vision systems or infrastructure. The system enables users to pull entire level(s) out to one side (left side, right side, front side, or back side) of the housing for preventative maintenance and/or component replacement. The case sequencer remains operative as long as one level (queuing bed) is active.

In still other examples, a robotic device loads the items into the case sequencer automatically without human intervention. In these examples, one or more robotic devices load the case(s) into the entry point of the first vertical transport mechanism for sorting, sequencing, and buffering.

The case sequencer in other examples includes case dimensioners, scanners, scales, and queue logic for sorting, sequencing, and buffering items, such as cases, boxes, packages, pallets, and/or other items based on size and other dimensions. Items having similar size, weight and/or cube cases are grouped by level and exit the case sequencer in groups to help improve downstream processes.

The system in other examples provides similar items together to improve case stacking in trailers for transport and/or unloading by either manual or automated solutions. This improves trailer utilization, improves automation, and reduces cycle time.

In another example, the case sequencer feeds like items to robotic palletizing cells. This enables pallet stability, department friendly stacking, improved throughput, and multiple pallet build.

The case sequencer in other examples feeds like-items to robotic or manual palletizing cells from multi-level modules. This allows for stock keeping unit (SKU) increases and palletization for stores.

The case sequencer enables the system to queue customer orders before pack-out. This enables elimination of touches from the sorter to put wall, reduce sorter length, and minimizes walk distance for pack-outs while leveraging vertical space utilized by the case sequencer.

The case sequencer in other examples improves sort and pallet build process for loose case trailers with significant number of SKUs from oversee containers. This minimizes walk time for sorting on the dock and improved pallet build time with better quality and improved trailer turn.

Alternatively, or in addition to the other examples described herein, examples include any combination of the following:
a threshold maximum number of slidable queuing beds in the extended position at a same time;
wherein the system remains operable as long as at least one slidable queuing bed is retracted in the operable state;
wherein the first vertical transport mechanism is a first spiral conveyor, and wherein the second vertical transport mechanism is a second spiral conveyor;
wherein the set of sensors comprises a set of dimensioners for measuring at least one dimension of each item in the plurality of items;
the set of sensors comprises a set of image capture devices for identifying a shape of each item in the plurality of items;
a slidable queuing bed further comprises a horizontal platform having a plurality of rollers for moving items having similar sizing dimensions from the first vertical transport mechanism to the second vertical transport mechanism;
a first spiral conveyor comprising a conveyor configured to move a plurality of items from a first level vertically downward to a last level;
a set of sensor devices generating sensor data associated with a set of dimensions of each item in the plurality of items;
a plurality of slidable queuing beds connected to the first spiral conveyor, each slidable queuing bed in a plurality of sliding queuing beds located at a different level, each slidable queuing bed configured to slide out of a housing via a sliding mechanism from a retracted position to an extended position, each slidable queuing bed configured to receive items from the first spiral conveyor having similar dimensions when in the retracted position;
a second spiral conveyor connected to the plurality of slidable queuing beds configured to receive items from the plurality of slidable queuing beds sorted based on the set of dimensions of each item, wherein a first set of items having a first set of dimensions exit the second spiral conveyor together, and wherein a second set of items having a second set of dimensions exit the second spiral conveyor together;
a set of sensors generating sensor data defining a set of dimensions of each item in the plurality of items;
a first set of conveyors moving the plurality of items entering the first spiral conveyor onto the plurality of slidable queuing beds at a plurality of levels in accordance with the set of dimensions of each item, wherein a first set of items having a first set of dimensions move onto a first slidable queuing bed at a first level, and wherein a second set of items having a second set of dimensions move onto a second slidable queuing bed at a second level;
wherein a slidable queuing bed further comprises a horizontal platform having a plurality of rollers for moving items having similar sizing dimensions from the first spiral conveyor to the second spiral conveyor;
wherein a threshold maximum number of queuing beds are capable of being extended simultaneously;
a plurality of storage areas for storing items exiting the plurality of slidable queuing beds having similar sizing dimensions, wherein the first set of items having the first set of dimensions are held in a first storage area for release from the second spiral conveyor substantially simultaneously, and wherein the second set of items having the second set of dimensions are held in a second storage area for release from the second spiral conveyor substantially simultaneously;
a first vertical transport mechanism comprising a set of sensors associated with an entry point generating sensor data defining a set of dimensions of each item entering the first vertical transport mechanism at the entry point;
a set of conveyors moving a plurality of items entering the first vertical transport mechanism at the entry point onto a plurality of slidable queuing beds at a plurality of levels in accordance with the set of dimensions of each item, wherein a first set of items having a first set of dimensions move onto a first slidable queuing bed at a first level, and wherein a second set of items having a second set of dimensions move onto a second slidable queuing bed at a second level, each slidable queuing bed in the plurality of slidable queuing beds comprising a horizontal platform having a plurality of rollers for moving items having similar sizing dimensions from the first vertical transport mechanism to a second vertical transport mechanism;
a queuing bed housing comprising a plurality of sliding mechanism associated with each queuing bed in the plurality of sliding queuing beds, wherein each queuing bed slides horizontally from a retracted position in an operable state to an extended position in an inoperable state via a sliding mechanism;
a plurality of storage areas for storing items exiting the plurality of slidable queuing beds having similar sizing dimensions, wherein the first set of items having the first set of dimensions are held in a first storage area for release from the second vertical transport mechanism substantially simultaneously, and wherein the second set of items having the second set of dimensions are held in a second storage area for release from the second vertical transport mechanism substantially simultaneously;
wherein the set of sensors comprises a set of dimensioners for measuring at least one dimension of each item in the plurality of items; and
a robotic device loading the plurality of items into the first vertical transport mechanism.

At least a portion of the functionality of the various elements in FIG. 1, FIG. 2, FIG. 3, FIG. 4, FIG. 5, FIG. 6, and FIG. 7 can be performed by other elements in FIG. 1, FIG. 2, FIG. 3, FIG. 4, FIG. 5, FIG. 6, and FIG. 7, or an entity (e.g., processor, web service, server, application program, computing device, etc.) not shown in FIG. 1, FIG. 2, FIG. 3, FIG. 4, FIG. 5, FIG. 6, and FIG. 7.

In some examples, the operations illustrated in FIG. 8 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

### Exemplary Operating Environment

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable, and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions, or the specific components or modules illustrated in the figures and described herein. Other examples of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

The indefinite articles “a” and “an,” as used in the specification and in the claims, unless clearly indicated to the contrary, should be understood to mean “at least one.” The phrase “and/or” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to “A” only (optionally including elements other than “B”); in another embodiment, to B only (optionally including elements other than “A”); in yet another embodiment, to both “A” and “B” (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either” “one of” “only one of” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of ‘A’ and ‘B’” (or, equivalently, “at least one of ‘A’ or ‘B’,” or, equivalently “at least one of ‘A’ and/or ‘B’”) can refer, in one embodiment, to at least one, optionally including more than one, “A”, with no “B” present (and optionally including elements other than “B”); in another embodiment, to at least one, optionally including more than one, “B”, with no “A” present (and optionally including elements other than “A”); in yet another embodiment, to at least one, optionally including more than one, “A”, and at least one, optionally including more than one, “B” (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for automatic case sequencing, the system comprising:
a first vertical transport mechanism comprising a set of sensors associated with an entry point, the set of sensor generating sensor data defining a set of dimensions of each item entering the first vertical transport mechanism;
a set of conveyors moving a plurality of items entering the first vertical transport mechanism at the entry point onto a plurality of slidable queuing beds at a plurality of levels in accordance with the set of dimensions of each item, wherein a first set of items having a first set of dimensions move onto a first slidable queuing bed at a first level, and wherein a second set of items having a second set of dimensions move onto a second slidable queuing bed at a second level;
a plurality of sliding mechanism associated with each queuing bed in a plurality of sliding queuing beds, wherein each queuing bed slides horizontally from a retracted position in an operable state to an extended position in an inoperable state via a sliding mechanism; and
a plurality of storage areas for storing items having similar sizing dimensions, wherein the first set of items having the first set of dimensions are held in a first storage area for release from a second vertical transport mechanism substantially simultaneously, and wherein the second set of items having the second set of dimensions are held in a second storage area for release from the second vertical transport mechanism substantially simultaneously.

2. The system of claim 1, further comprising:
a threshold maximum number of slidable queuing beds in the extended position at a same time.

3. The system of claim 1, wherein the system remains operable as long as at least one slidable queuing bed is retracted in the operable state.

4. The system of claim 1, wherein the first vertical transport mechanism is a first spiral conveyor, and wherein the second vertical transport mechanism is a second spiral conveyor.

5. The system of claim 1, wherein the set of sensors comprises a set of dimensioners for measuring at least one dimension of each item in the plurality of items.

6. The system of claim 1, wherein the set of sensors comprises a set of image capture devices for identifying a shape of each item in the plurality of items.

7. The system of claim 1, wherein a slidable queuing bed further comprises:
a horizontal platform having a plurality of rollers for moving items having similar sizing dimensions from the first vertical transport mechanism to the second vertical transport mechanism.

8. A case sequencer comprising:
a first spiral conveyor comprising a conveyor configured to move a plurality of items from a first level vertically downward to a last level;
a set of sensor devices generating sensor data associated with a set of dimensions of each item in the plurality of items;
a plurality of slidable queuing beds connected to the first spiral conveyor, each slidable queuing bed in a plurality of sliding queuing beds located at a different level, each slidable queuing bed configured to slide out of a housing via a sliding mechanism from a retracted position to an extended position, each slidable queuing bed configured to receive items from the first spiral conveyor having similar dimensions when in the retracted position; and
a second spiral conveyor connected to the plurality of slidable queuing beds configured to receive items from the plurality of slidable queuing beds sorted based on the set of dimensions of each item, wherein a first set of items having a first set of dimensions exit the second spiral conveyor together, and wherein a second set of items having a second set of dimensions exit the second spiral conveyor together.

9. The case sequencer of claim 8, further comprising:
a set of sensors generating sensor data defining a set of dimensions of each item in the plurality of items.

10. The case sequencer of claim 8, further comprising:
a first set of conveyors moving the plurality of items entering the first spiral conveyor onto the plurality of slidable queuing beds at a plurality of levels in accordance with the set of dimensions of each item, wherein a first set of items having a first set of dimensions move onto a first slidable queuing bed at a first level, and wherein a second set of items having a second set of dimensions move onto a second slidable queuing bed at a second level.

11. The case sequencer of claim 8, wherein a slidable queuing bed further comprises:
a horizontal platform having a plurality of rollers for moving items having similar sizing dimensions from the first spiral conveyor to the second spiral conveyor.

12. The case sequencer of claim 8, wherein a threshold maximum number of queuing beds are capable of being extended simultaneously.

13. The case sequencer of claim 8, further comprising:
a plurality of storage areas for storing items exiting the plurality of slidable queuing beds having similar sizing dimensions, wherein the first set of items having the first set of dimensions are held in a first storage area for release from the second spiral conveyor substantially simultaneously, and wherein the second set of items having the second set of dimensions are held in a second storage area for release from the second spiral conveyor substantially simultaneously.

14. The case sequencer of claim 8, wherein the case sequencer remains operable as long as at least one slidable queuing bed is retracted in an operable state.

15. An apparatus for automatic case sequencing and buffering, the apparatus comprising:
a first vertical transport mechanism comprising a set of sensors associated with an entry point generating sensor data defining a set of dimensions of each item entering the first vertical transport mechanism at the entry point;
a set of conveyors moving a plurality of items entering the first vertical transport mechanism at the entry point onto a plurality of slidable queuing beds at a plurality of levels in accordance with the set of dimensions of each item, wherein a first set of items having a first set of dimensions move onto a first slidable queuing bed at a first level, and wherein a second set of items having a second set of dimensions move onto a second slidable queuing bed at a second level, each slidable queuing bed in the plurality of slidable queuing beds comprising a horizontal platform having a plurality of rollers for moving items having similar sizing dimensions from the first vertical transport mechanism to a second vertical transport mechanism;
a queuing bed housing comprising a plurality of sliding mechanism associated with each queuing bed in the plurality of sliding queuing beds, wherein each queuing bed slides horizontally from a retracted position in an operable state to an extended position in an inoperable state via a sliding mechanism; and
a plurality of storage areas for storing items exiting the plurality of slidable queuing beds having similar sizing dimensions, wherein the first set of items having the first set of dimensions are held in a first storage area for release from the second vertical transport mechanism substantially simultaneously, and wherein the second set of items having the second set of dimensions are held in a second storage area for release from the second vertical transport mechanism substantially simultaneously.

16. The apparatus of claim 15, wherein a threshold maximum number of slidable queuing beds are capable of sliding out into the extended position at a same time.

17. The apparatus of claim 15, wherein the apparatus remains operable where at least one slidable queuing bed is retracted in the operable state.

18. The apparatus of claim 15, wherein the first vertical transport mechanism is a first spiral conveyor, and wherein the second vertical transport mechanism is a second spiral conveyor.

19. The apparatus of claim 15, wherein the set of sensors comprises a set of dimensioners for measuring at least one dimension of each item in the plurality of items.

20. The apparatus of claim 15, comprising:
a robotic device loading the plurality of items into the first vertical transport mechanism.
